(19) United States
(12) Patent Application Publication
(10) Pub. No.: US 2012/0158520 A1
(43) Pub. Date: Jun. 21, 2012

(54) CONTEXT AWARE ADVERTISEMENT DELIVERY

(75) Inventors: Brian Momeyer, Carlsbad, CA (US); Babak Forutanpour, San Diego, CA (US); Roman Tivyan, San Diego, CA (US)

(73) Assignee: QUALCOMM INCORPORATED, San Diego, CA (US)

(21) Appl. No.: 12/970,667

(22) Filed: Dec. 16, 2010

(51) Int. Cl. G06Q 30/00

(52) U.S. Cl. 705/14.69

(57) ABSTRACT

Sensor data indicating the motion level of a mobile platform is used to determine a rate, or cost-per-impression (CPM), to be charged for an advertisement displayed on the mobile platform. Additional data may be used to determine an attention level of a user of the mobile platform, which is used to determine the rate of the advertisement. The determination of the rate for the advertisement maybe determined by the mobile platform and transmitted to a server. Alternatively, a server may determine the rate for the advertisement based on sensor data received from the mobile platform. Additionally, the amount of information or text in an advertisement may be adjusted based on the motion level or attention level of the mobile platform.

### BACKGROUND

Currently advertisements on electronic media, such as Web TVs, personal computers (PCs), laptops, tablet computers, mobile phones, etc. are served at a fixed cost-per-impression (CPM) rate. Thus, if a user visits a website from a PC, the advertisement served is likely 800×240 in resolution, while on a mobile phone, due to the smaller display, the same advertisement is modified to fit within a resolution of 480×64. Currently, advertisements are served at a fixed cost-per-impression (CPM) rate regardless of the context of the device.

### SUMMARY

Sensor data indicating the motion level of a mobile platform is used to determine a rate, or cost-per-impression (CPM), to be charged for an advertisement displayed on the mobile platform. Additional data may be used to determine an attention level of a user of the mobile platform, which is used to determine the rate of the advertisement. The determination of the rate for the advertisement may be determined by the mobile platform and transmitted to a server. Alternatively, a server may determine the rate for the advertisement based on sensor data received from the mobile platform. Additionally, the amount of information or text in an advertisement may be adjusted based on the motion level or attention level of the mobile platform.

### BRIEF DESCRIPTION OF THE DRAWING

FIG. 1 illustrates a block diagram showing a system, including a mobile platform and a server that communicate to determine a rate to be charged for an advertisement displayed on the mobile platform based on sensor data indicating the amount of motion of the mobile platform.

FIG. 2A illustrates an advertisement that may be provided if the user's attention level is low or if there is a high level of motion of the mobile platform.

FIG. 2B illustrates an advertisement similar to that shown in FIG. 2A, but with additional information that may be provided if the user's attention level is high or if there is a low level of motion of the mobile platform.

FIG. 3 is a flow chart illustrating using the motion of a mobile platform to determine the rate or CPM charge for an advertisement.

FIG. 4 is a block diagram of a mobile platform that uses sensor data indicative of the motion level to determine the rate charged for a displayed advertisement.

FIG. 5 is a block diagram of a server that is accessed by a mobile platform to adjust the rate charged for a displayed advertisement based on sensor data indicative of the motion level of the mobile platform.

### DETAILED DESCRIPTION

A system and method described herein uses real-time motion of a mobile platform during the time that an advertisement is served to adjust the rate, or the cost-per-impression (CPM), charged of the advertisement. The adjustable CPM rates will allow advertisers to have more confidence that the right advertisements are reaching their potential customers at the most opportune moments.

The motion of the mobile platform may be used directly to adjust the CPM or may be used with additional factors to generate an attention level of the mobile platform user, which is then used to adjust the CPM. Additionally, the content of advertisements appearing on the mobile platform may be altered to be suitable for the motion of the mobile platform and/or attention level of the user. For example, a low level of motion or a higher attention level of the user suggests that the user is more likely to pay attention to an advertisement and can absorb additional information in the advertisement. Conversely, a high level of motion or a lower attention level of the user indicates that the user is less likely to pay attention to an advertisement and will absorb less information. Accordingly, the rate charged for advertisements displayed while the mobile platform or the user has a low attention level, or the mobile platform is subject to a large amount of motion, is lower than the rates charged for advertisements displayed while the mobile platform is subject to little motion or the user has a high attention level. The motion level may be determined based on the output of the physical sensors in the mobile platform, such as accelerometers, gyroscopes, compass, or other sensors, such as a satellite positioning system (SPS). If attention level is used, the attention level may be determined based on the output of the physical sensors in the mobile platform as well as other parameters, such as the current use of the mobile platform, as well as usage patterns and other similar parameters.

As used herein, a mobile platform refers to a device such as a cellular or other wireless communication device, personal communication system (PCS) device, personal navigation device, Personal Information Manager (PIM), Personal Digital Assistant (PDA), laptop, tablet computer, or other suitable mobile device which is capable of receiving wireless communications. The term “mobile platform” is intended to include all devices, including wireless communication devices, computers, laptops, etc. which are capable of communication with a server, such as via the Internet, Wi-Fi, or other network. Any operable combination of the above is also considered a “mobile platform.”

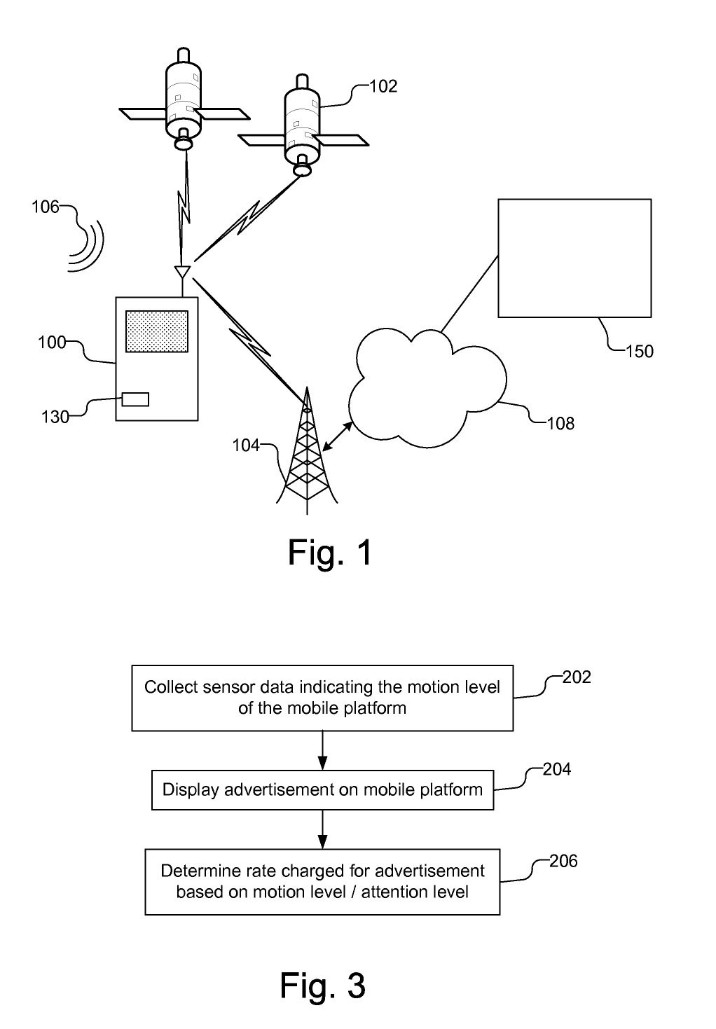

FIG. 1 illustrates a block diagram showing a system, including a mobile platform 100 and a server 150 that communicate to establish the advertisement that is displayed, the motion level of the mobile platform or the attention level of the user, and the CPM for the advertisement. Additionally, the content of advertisements served may be altered to be suitable for the motion level of the mobile platform or the attention level of the user.

The mobile platform 100 may access server 150 to transmit and/or receive data using various wireless communication networks 108, such as a wireless wide area network (WWAN), a wireless local area network (WLAN), a wireless personal area network (WPAN), and so on, via cellular towers 104 and from wireless communication access points 106, or using satellite vehicles 102 if desired. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

The mobile platform 100 may include a SPS receiver to determine the position of the mobile platform 100 as well as the velocity of the mobile platform 100. An SPS system typically includes a system of transmitters positioned to enable entities to determine their location on or above the Earth based, at least in part, on signals received from the transmitters. In a particular example, such transmitters may be located on Earth orbiting satellite vehicles (SVs) 102, illustrated in FIG. 1. For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile platform 100 collects sensor data, such as data from motion sensors, ambient light sensor, proximity sensors, and rate of travel via SPS, as generally indicated by sensor data unit 130. The mobile platform 100 may calculate the real-time motion of the mobile platform 100 during the time that an advertisement is served based on the data from the sensor data unit 130. The amount of motion of the mobile platform 100 may then be used to adjust the CPM charged for the advertisements. By way of example, the final CPM_{Final} charged for an advertisement may be calculated as follows:

$${CPM}_{Final} = {\sum }_{i = 0}^{n} \frac{( {CPM}_{Fixed} - mag\_acc ( x , y , z ) * {w}_{1} - vel * {w}_{2}}{n} \qquad eq . 1$$

Where CPM_{Fixed} is a fixed CMP rate, mag_acc(x,y,z) is the total magnitude of three-dimensional accelerometers, vel is the rate of travel as determined by an SPS, w₁ and w₂ are weighting factors and n is the total seconds that the advertisement was served.

For real-time performance, the server 150 may provide the mobile platform 100 with a plurality of advertisements, each of which has a different amount of text or information. The mobile platform 100 may store the advertisements locally and determine in real-time which advertisement to display at any given window of time based on the detected motion level of the mobile platform 100. The mobile platform 100 may provide the server with information related to the advertisement so that the appropriate CPM may be charged. For example, the mobile platform 100 may provide the duration and the CPM_{Final} to the server 150. If desired, additional information may be provided, such as the advertisement served, the duration, and the motion (mag_acc(x,y,z) and vel) for every second that the advertisement was served and the server 150 may calculate the CPM_{Final}.

Additionally, instead of using only the motion level of the mobile platform 100, additional data may be collected and used to determine the attention level of the user of the mobile platform 100. For example, the current usage of the mobile platform 100 and usage patterns may be collected. For example, if the user is typing, it may be desirable to reduce the CPM and provide more bold advertisements. Further data from biorhythm sensors and galvanic skin response sensors may be collected and used to determine the users emotional state and mood, as advertisement content is better absorbed and retained when the subject in an emotional state (positive or negative). Using the collected data, an attention level for the user of the mobile platform 100 may be calculated, for example, as follows:

A=W₁*D+W₂*S+W₃*E eq. 2

The attention level “A” is the likelihood that an advertisement is being consumed. “D” is the duration of device activity, which may be monitored using a timer. For example, reading a web page takes longer than a quick glance at a map, and therefore will have a greater duration D. S″ is the user state and may be determined as follows:

TABLE 1

| State (S) | Activity |
|---|---|
| 0.1 | Driving, taking quick glances at device |
| 0.2 | Talking on speakerphone, taking quick |
| | glances at device |
| 0.3 | Talking on speakerphone, reading device |
| 0.4 | Walking, taking quick glances at device |
| 0.5 | Walking, reading device |
| 0.6 | Standing, taking quick glances at device |
| 0.7 | Seated, taking quick glances at device |
| 0.8 | In moving vehicle, reading on device |
| 0.9 | Standing, stationary, reading on device |
| 1 | Seated, stationary, reading on device |

The activity of the user may be determined using the collected sensor data. For example, using GPS data, it can be determined if the mobile platform 100 is relatively stationary or moving in a car. Similarly, motion sensors, such as accelerometers, gyroscopes, and compass, can indicate whether the user is walking or stationary, standing or seated, as well whether the user is reading the device (in which case the mobile platform 100 would be held relatively stationary) or taking quick glances at the device, indicated by quick movement of the device to a reading position and then return to the original position. Additionally, proximity sensors, which may be a light sensor, capacitive sensors, resistive sensors, etc. may be used to determine if the user is talking into the mobile platform 100 with the mobile platform 100 held up to the user's head, where the user cannot see the screen; or to determine if the mobile platform 100 is in a purse or pocket. An ambient light detector may be used, e.g., to determine whether it is daytime/nighttime or if the mobile platform is inside/outside, which may be used adjust the brightness or colors of the advertisement. A higher state level indicates that the device context is one in which the user will be more likely to pay attention to an advertisement. Of course, other or additional activities may be associated with different states (S).

Additionally, “E” is the emotional state of the user. The emotional state can also follow a graduated scale with neutral emotional state given a value of zero and an extremely positive or negative emotional state given a 1 with values in between. Finally, “Wx” in equation 2 are weighting factors.

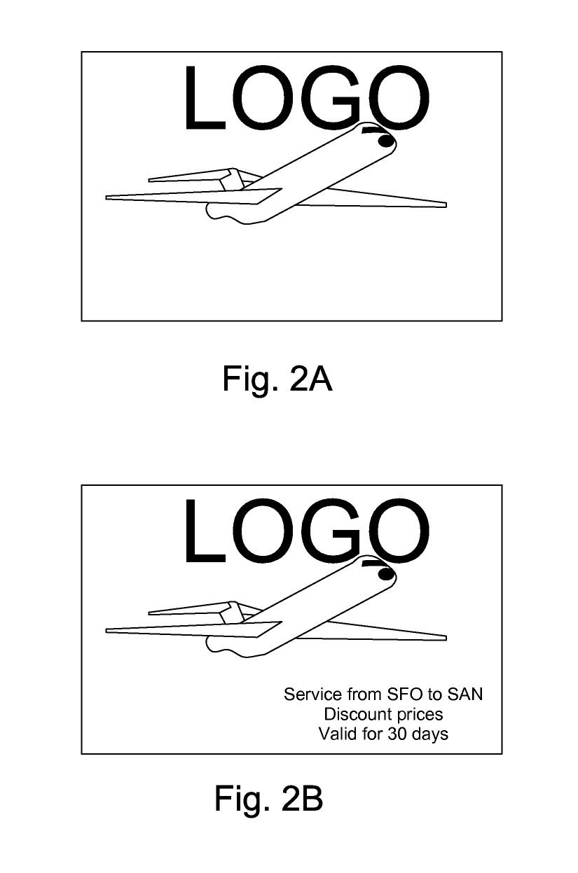

The mobile platform 100 may provide the sensor data to the server 150 via network 108 and the server 150 may then determine the attention level A. Alternatively, the mobile platform 100 may process the sensor data to determine the attention level A, and simply provide the attention level A to the server 150. Based on the attention level A, the server 150 may provide an advertisement to the mobile platform 100 and adjust the CPM for the advertisement. For example, the CPM for the advertisement may be determined simply as CPM_{Final}=CPM_{Fixed}*A. If desired, the server 150 may alter the advertisement provided based on the attention level A, i.e., a high attention level results in an advertisement with additional text or information and conversely, a lower attention level results in an advertisement with less text or information. For example, FIG. 2A illustrates an advertisement that may be provided if the user's attention level is low (or there is a high level of motion of the mobile platform) and FIG. 2B illustrates a similar advertisement with additional information that may be provided if the user's attention level is high (or there is a low level of motion of the mobile platform).

Alternatively, as discussed above, the server 150 may provide a number of advertisements to the mobile platform 100, which are stored locally on the mobile platform 100. The mobile platform 100 may process the sensor data to determine the attention level A, and based on the attention level A decide which advertisement to display. The mobile platform 100 may discard the remaining advertisements or retain them for future use. The mobile platform 100 may then provide the server 150 with a descriptor of the advertisement displayed as well as the either the attention level “A” or the CPM based on the attention level. Whether the mobile platform 100 or server 150 determines the attention level and how different advertisements may be provided to the mobile platform 100 may vary based on cost of data transfer between the mobile platform 100 and the server 150, the rate of data transmission, and processing power of the server 150 versus the processing power of the mobile platform 100.

Additionally, if an incoming call or SMS or other popup covers a displayed advertisement, the mobile platform 100 may report this to the server 150, which may adjust the cost accordingly.

FIG. 3 is a flow chart illustrating using the motion of a mobile platform to determine the rate or CPM charge for an advertisement. As shown in FIG. 3, sensor data indicating the motion level of the mobile platform is collected (202). Additional data may also be collected, such as the current usage of the mobile platform as described above. The advertisement is displayed on the mobile platform (204) and the rate charged for the advertisement is determined based on the motion level of the mobile platform (206). The determination of the rate charged for the advertisement may be made before, after or during the display of the advertisement. Moreover, the determination of the rate may be performed by the mobile platform or by the server. The rate may be determined based on a calculation based on the sensor data, e.g., as illustrated in equation 1. Alternatively, a number of different fixed rates may be associated with different amounts of information in an advertisement. The advertisement, or more specifically, the amount of information in the advertisement, may be selected based on the motion level of the mobile platform and the rate associated with the selected advertisement is charged for the advertisement.

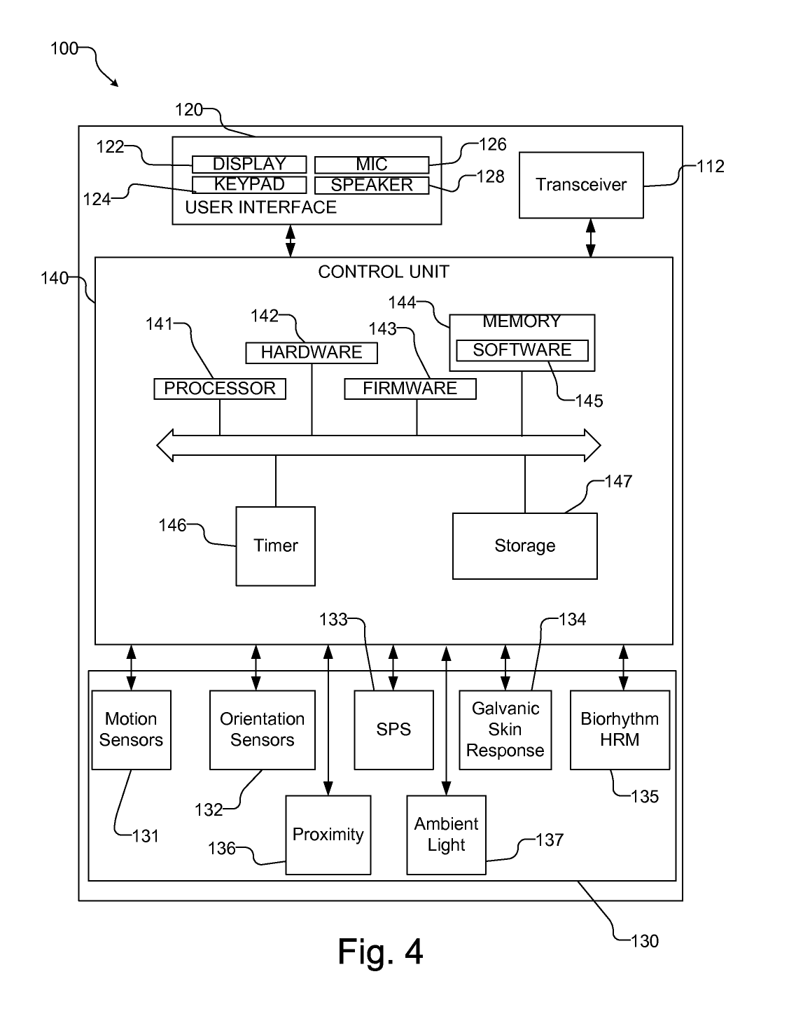

FIG. 4 is a block diagram of a mobile platform 100 that uses sensor data indicative of the motion level to determine the rate charged for a displayed advertisement. The mobile platform 100 includes a means for determining motion of the mobile platform.

The mobile platform 100 includes a wireless transceiver 112, e.g. a cellular modem or a wireless network radio receiver/transmitter that is capable of sending and receiving communications to and from a cellular tower or from a wireless access point, respectively. The mobile platform 100 further includes a user interface 120 that includes a display 122 for displaying advertisements and a keypad 124 or other input device through which the user can input information into the mobile platform 100. If desired, the keypad 124 may be obviated by integrating a virtual keypad into the display 122 with a touch sensor. The user interface 120 may also include a microphone 126 and speaker 128.

The mobile platform 100 further includes a plurality of sensors, illustrated as part of the sensor data unit 130. By way of example, the mobile platform may include motion sensors 131, such as accelerometers, orientation sensors 132, which may include gyroscopes and/or an electronic compass, and an SPS unit 133 capable of receiving positioning signals from an SPS system. Additional sensors may be included, such as galvanic skin response sensors 134, biorhythm heart rate monitor (HRM) 135, as well as proximity sensors 136 and an ambient light detector 137. Moreover, the motion sensors 131 and/or orientation sensors 132 may be used as a user interface 120.

The mobile platform 100 includes a control unit 140 that is connected to accept and process data from the sensor data unit 130, transceiver 112, and user interface 120. The control unit 140 also controls the operation of the devices. The control unit 140 may be provided by a processor 141 and associated memory 144, hardware 142, software 145, and firmware 143. The control unit 140 further includes a timer 146 for, e.g., determining the duration “D” of an activity described in equation 2 and/or determining the time that an advertisement is served. The control unit 140 may also include storage 147, which may be memory for temporary or long term storage of advertisements received from a server. The storage 147 is illustrated separately from memory 144 for clarity, but may be the same as or part of memory 144. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

It will be understood as used herein that the processor 141 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile platform, and is not to be limited to any particular type of memory or number of memories, or type of media upon which memory is stored.

The methodologies described herein may be implemented by various means depending upon the application. For example, these methodologies may be implemented in hardware 142, firmware 143, software 145, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 144 and executed by the processor 141. For example, software 145 may include program codes stored in memory 144 and executed by the processor 141 and may be used to run the processor and to control the operation of the mobile platform 100 as described herein. A program code stored in a computer-readable medium, such as memory 144, may include program code program code program code to store sensor data indicating a motion level of the mobile platform; and program code to determine a rate charged for an advertisement displayed by the mobile platform based on the sensor data. Additionally, program code stored in a computer-readable medium may include program code to determine an attention level of a user of the mobile platform based on the motion level, and program code to select an advertisement to display on the mobile platform based on the motion level of the mobile platform. The program code stored in a computer-readable medium may additionally include program code to cause the processor to control any operation of the mobile platform 100 as described herein.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

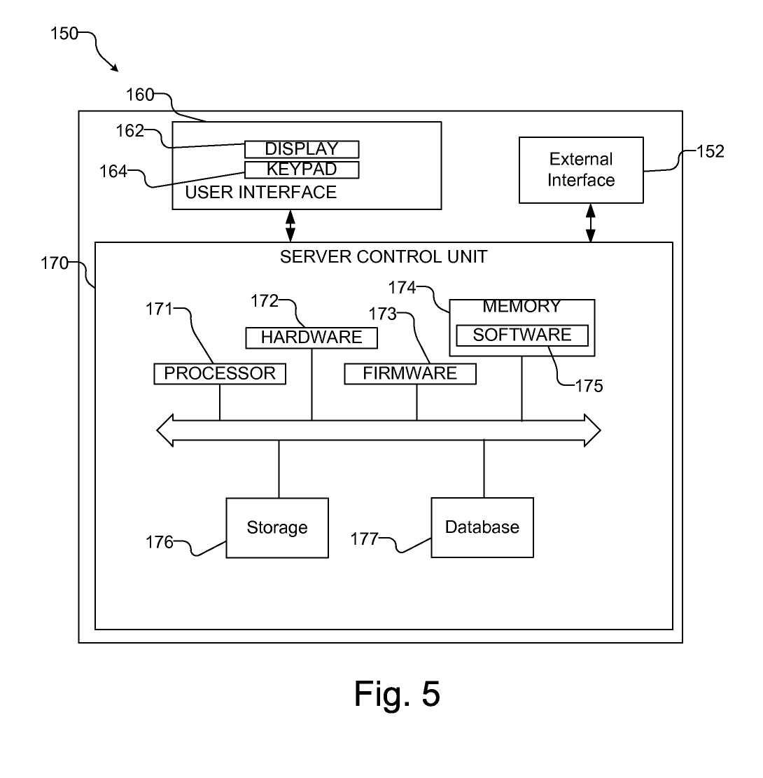

FIG. 5 is a block diagram of a server 150 that is accessed by a plurality of mobile platforms 100 to adjust the rate charged for a displayed advertisement based on motion of the mobile platforms 100. While FIG. 5 illustrates a single server 150, it should be understood that multiple servers communicating over external interface 152 may be used. The server 150 includes an external interface 152 coupled to the network 108 (shown in FIG. 1) for receiving data from the mobile platforms 100, as well providing advertisements or any additional information, to the mobile platforms 100. The external interface 152 may be a wired communication interface or a wireless interface. The server 150 further includes a user interface 160 that includes, e.g., a display 162 and a keypad 164 or other input device through which the user can input information into the server 150.

The server 150 includes a control unit 170 that is connected to accept and process data from the external interface 152 and to control the operation and data transmission via external interface 152. The control unit 170 may be provided by a processor 171 and associated memory 174, hardware 172, software 175, and firmware 173 if desired. The control unit further includes storage 176, which may be memory for temporary or long term storage of advertisements to be transmitted to the mobile platform 100. The control unit 170 further includes a database 177 for storing the accumulated charges for advertisements served, as determined by the server 150 or reported by the mobile platform 100. The database may include any additional information provided by the mobile platform 100, such as motion level, attention level, advertisement displayed and duration of display, which may be provided to the advertising client. The database 177 and storage 176 may be the same or different as memory 174, but are illustrated separately for clarity. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

It will be understood as used herein that the processor 171 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile platform, and is not to be limited to any particular type of memory or number of memories, or type of media upon which memory is stored.

The methodologies described herein may be implemented by various means depending upon the application. For example, these methodologies may be implemented in hardware 172, firmware 173, software 175, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 174 and executed by the processor 171. For example, software 175 may include program codes stored in memory 174 and executed by the processor 171 and may be used to run the processor and to control the operation of the server 150 as described herein. A program code stored in a computer-readable medium, such as memory 174, may include program code program code program code to store sensor data indicating a motion level of the mobile platform; and program code to determine a rate charged for an advertisement displayed by the mobile platform based on the sensor data. Additionally, program code stored in a computer-readable medium may include program code to determine an attention level of a user of the mobile platform based on the motion level, and program code to select an advertisement to display on the mobile platform based on the motion level of the mobile platform. The program code stored in a computer-readable medium may additionally include program code to cause the processor to control any operation of the server 150 as described herein.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

A means for determining a motion level of a mobile platform based on the sensor data and means for determining a rate charged for the advertisement based on the motion level of the mobile platform, which may be implemented by the processor 141, 171 and software 145, 175, or in separate control units in the mobile platform 100 or server 150, respectively. Similarly, a means for determining an attention level of a user of the mobile platform based on the motion level of the mobile platform and a means for selecting an advertisement to display on the mobile platform based on the motion level of the mobile platform may be implemented by the processor 141, 171 and software 145, 175, or in separate control units in the mobile platform 100 or server 150, respectively. A means for displaying an advertisement on the mobile platform may include the display 122 in the mobile platform 100.

Although the present invention is illustrated in connection with specific embodiments for instructional purposes, the present invention is not limited thereto. Various adaptations and modifications may be made without departing from the scope of the invention. Therefore, the spirit and scope of the appended claims should not be limited to the foregoing description.

What is claimed is:

1. A method comprising:
collecting sensor data indicating a motion level of a mobile platform;
displaying an advertisement on the mobile platform; and
determining a rate charged for the advertisement based on the motion level of the mobile platform.

2. The method of claim 1, further comprising using the sensor data indicating the motion level to determine an attention level of a user, wherein the rate charged for the advertisement is based on the attention level.

3. The method of claim 2, wherein the attention level of the user is determined as a function of duration of activity on the mobile platform and a user state.

4. The method of claim 3, further comprising determining the user state using the sensor data, wherein the user state comprises at least one of standing, sitting, walking, talking, driving, reading from the mobile platform, and glancing at the mobile platform.

5. The method of claim 3, further comprising collecting at least one of heart rate sensor data and galvanic skin response data, wherein the attention level of the user is further determined as a function of the at least one of heart rate sensor data and galvanic skin response data.

6. The method of claim 3, further comprising collecting user proximity data indicating a location of the user with respect to the mobile platform, wherein the attention level of the user is further determined as based on the user proximity data.

7. The method of claim 1, further comprising collecting ambient light data and adjusting at least one brightness and color of the advertisement based on the ambient light data.

8. The method of claim 1, wherein collecting sensor data indicating the motion level of the mobile platform comprises collecting sensor data from at least one of a motion sensors, orientation sensors, and a satellite positioning system.

9. The method of claim 1, wherein determining the rate charged for the advertisement based on the motion level of the mobile platform comprises decreasing the rate when the motion level of the mobile platform increases.

10. The method of claim 1, further comprising selecting the advertisement to display on the mobile platform based on the motion level of the mobile platform.

11. The method of claim 10, wherein selecting the advertisement to display on the mobile platform based on the motion level of the mobile platform comprises providing less information in the advertisement when the motion level of the mobile platform increases.

12. The method of claim 10, wherein determining the rate charged for the advertisement comprises associating different rates for different amounts of information in the advertisement and selecting the advertisement to display on the mobile platform based on the motion level of the mobile platform and charging the rate associated with the advertisement selected.

13. The method of claim 10, wherein selecting the advertisement to display is performed by a server, the method further comprising receiving a selected advertisement from the server.

14. The method of claim 10, the method further comprising receiving from a server a plurality of advertisements with different amounts of information, wherein selecting the advertisement to display comprises selecting from the plurality of advertisements.

15. The method of claim 1, wherein determining the rate charged for the advertisement based on the motion level of the mobile platform is performed by the mobile platform and is transmitted to a server.

16. The method of claim 1, further comprising transmitting the sensor data to a server, wherein determining the rate charged for the advertisement based on the motion level of the mobile platform is performed by the server.

17. A mobile platform comprising:
a plurality of motion sensors;
a wireless transceiver;
a processor connected to the plurality of motion sensors and the wireless transceiver;
memory connected to the processor;
a display connected to the memory; and
software held in the memory and run in the processor to cause the processor to collect sensor data from the plurality of motion sensors, to display an advertisement on the display, to determine a rate to charge for the advertisement based on the sensor data, and to transmit the rate to a server with the wireless transceiver.

18. The mobile platform of claim 17, wherein the plurality of motion sensors comprise at least one of accelerometers, gyroscopes, electronic compass, and a satellite positioning system receiver.

19. The mobile platform of claim 17, wherein the software run in the processor causes the processor to determine an attention level of a user of the mobile platform based on the sensor data and to determine the rate based on the attention level.

20. The mobile platform of claim 19, further comprising a timer coupled to the processor to provide data related to a duration of activity, wherein the attention level of the user is determined as a function of the duration of activity.

21. The mobile platform of claim 19, further comprising determining a user state using the sensor data, wherein the user state comprises at least one of standing, sitting, walking, talking, driving, reading from the mobile platform, and glancing at the mobile platform, wherein the attention level of the user is determined as a function of the user state.

22. The mobile platform of claim 19, further comprising at least one of a galvanic skin response sensor and a heart rate sensor coupled to provide at least one of a galvanic skin response data and heart rate data to the processor, wherein the software run in the processor causes the processor to determine the attention level of a user of the mobile platform further based on the at least one of the galvanic skin response data and the heart rate data.

23. The mobile platform of claim 19, further comprising at least one proximity sensor coupled to provide user proximity data to the processor, wherein the software run in the processor causes the processor to determine the attention level of a user of the mobile platform further based on the user proximity data.

24. The mobile platform of claim 17, further comprising a light sensor coupled to provide ambient light data to the processor, wherein the software run in the processor causes the processor to adjust at least one of brightness and color of the advertisement displayed on the display based on the ambient light data.

25. The mobile platform of claim 17, wherein the rate to charge is decreased when the sensor data indicates increased motion level of the mobile platform.

26. The mobile platform of claim 17, wherein the software run in the processor causes the processor to select an advertisement to display based on the sensor data.

27. The mobile platform of claim 26, wherein the advertisement to display is selected to provide less information when the sensor data indicates increased motion level of the mobile platform.

28. The mobile platform of claim 27, wherein different rates to charge are associated with different amounts of information in the advertisement, and wherein the rate is transmitted to a server by transmitting an identifier of the advertisement that is selected.

29. The mobile platform of claim 26, wherein the software run in the processor causes the processor to store a plurality of advertisements with different amounts of information received from a server by the wireless transceiver, wherein the advertisement to display is selected from the plurality of advertisements.

30. A server comprising:
an external interface;
a processor connected to the external interface;
memory connected to the processor; and
software held in the memory and run in the processor to cause the processor to store in the memory sensor data received from a mobile platform by the external interface, the sensor data indicating a motion level of the mobile platform, and to determine a rate charged for an advertisement displayed by the mobile platform based on the sensor data.

31. The server of claim 30, wherein the software run in the processor causes the processor to determine an attention level of a user of the mobile platform based on the sensor data and to determine the rate based on the attention level.

32. The server of claim 31, further comprising determining a user state using the sensor data, wherein the user state comprises at least one of standing, sitting, walking, talking, driving, reading from the mobile platform, and glancing at the mobile platform, wherein the attention level of the user is determined as a function of duration of activity on the mobile platform and the user state.

33. The server of claim 31, wherein the software run in the processor causes the processor to store in memory at least one of a galvanic skin response data and a heart rate data received from the mobile platform, wherein the attention level of the user of the mobile platform is further based on the at least one of the galvanic skin response data and the heart rate data.

34. The server of claim 30, wherein the rate to charge is decreased when the sensor data indicates increased motion level of the mobile platform.

35. The server of claim 30, wherein the software run in the processor causes the processor to select an advertisement based on the sensor data and to transmit the advertisement to the mobile platform by the external interface.

36. The server of claim 35, wherein the advertisement to display is selected to provide less information when the sensor data indicates increased motion level of the mobile platform.

37. The server of claim 36, wherein different rates to charge are associated with different amounts of information in advertisements, and wherein the rate is determined based on the advertisement selected.

38. A system comprising:
means for determining a motion level of a mobile platform;
means for displaying an advertisement on the mobile platform; and
means for determining a rate charged for the advertisement based on the motion level of the mobile platform.

39. The system of claim 38, further comprising means for determining an attention level of a user of the mobile platform based on the motion level, wherein the means for determining a rate uses the attention level.

40. The system of claim 38, wherein the means for determining the rate decreases the rate when the motion level of the mobile platform increases.

41. The system of claim 38, further comprising means for selecting an advertisement to display on the mobile platform based on the motion level of the mobile platform.

42. A computer-readable medium including program code stored thereon, comprising:
program code to store sensor data indicating a motion level of a mobile platform; and
program code to determine a rate charged for an advertisement displayed by the mobile platform based on the sensor data.

43. The computer-readable medium of claim 42, further comprising program code to determine an attention level of a user of the mobile platform based on the motion level, wherein the program code to determine a rate uses the attention level.

44. The computer-readable medium of claim 42, further comprising program code to select an advertisement to display on the mobile platform based on the motion level of the mobile platform.
